(19) United States
(12) Patent Application Publication
(10) Pub. No.: US 2023/0365420 A1
(43) Pub. Date: Nov. 16, 2023

(54) DESILICATED SMALL CRYSTAL ZSM-5 AND METHOD OF MAKING THE SAME

(71) Applicant: Ecovyst Inc., Conshohocken, PA (US)

(72) Inventors: Anton PETUSHKOV, Malvern, PA (US); Hong-Xin LI, Lansdale, PA (US)

(21) Appl. No.: 18/184,030

(22) Filed: Mar. 15, 2023

Related U.S. Application Data
(60) Provisional application No. 63/319,921, filed on Mar. 15, 2022.

(51) Int. Cl. C01B 39/40

(52) U.S. Cl. CPC C01B 39/40; C01P 2002/70; C01P 2004/64; C01P 2006/14

(57) ABSTRACT

A desilicated crystalline material having an MFI (ZSM-5) framework type, a molar silica to alumina ratio (SAR) of 15 or more, and mean crystal size of about 200 nm or less, is disclosed. The disclosed crystalline material has a mesopore volume of at least 0.40 cm³/g and a micropore volume of at least 0.10 cm³/g. A method of preparing a desilicated crystalline material is also disclosed. The method comprises mixing a starting ZSM-5 material having a mean crystal size of 200 nm or less in a base solution, collecting the solids by filtration or other separation methods, drying, and optionally calcining the solids.

This application claims priority to U.S. Provisional Patent Application No. 63/319,921, filed Mar. 15, 2022, which is hereby incorporated by reference in its entirety.

### TECHNICAL FIELD

The present disclosure relates generally to ZSM-5 zeolite with improved mesoporosity. The present disclosure also relates to methods of making ZSM-5 by desilication of a small crystal ZSM-5 zeolite.

### BACKGROUND

Mesoporous zeolites are a class of zeolites with high mesopore volumes (in contrast to conventional zeolites with low or absent mesoporosity) that are well known for their improved diffusion properties. The faster diffusion within mesopores provides better access of reactants to the catalytic sites in the zeolite micropores and can result in an improved catalytic performance of such materials.

Increased mesoporosity in a zeolite can be achieved by a variety of methods. One method is using mesoporogens during the zeolite synthesis. Mesoporogens are typically organic compounds that form and fill mesopores during the zeolite synthesis. Another method is synthesis of nanosized zeolites, which have short diffusion distances within individual crystals and possess intercrystalline mesoporosity. Yet another method is selective removal of a part of the zeolite framework, wherein the formed voids are within the mesopore size range. Selective removal of the zeolite framework is typically done by the process of zeolite desilication with a suitable base. A part of the zeolite framework is dissolved during the desilication process and represents a loss of material, which can result in an increase of the production costs.

Each of these methods have inherent limitations in terms of cost or final mesopore structure. Thus, there is a need discover a suitable zeolite material, which mesoporosity can be improved at the cost of a minimal loss of the material during the desilication process.

ZSM-5 zeolite (MFI framework, as defined by the IZA) is used in industry for many petrochemical applications. A ZSM-5 zeolite can be synthesized with or without organic structural direction agent (OSDA) such as tetrapropylammonium bromide. A ZSM-5 zeolite with improved mesoporosity produced with a minimal loss during the desilication can be an advantageous material for such applications.

Thus, there is a need to develop a ZSM-5 zeolite that can be desilicated to increase its mesoporosity in an economical fashion, such as achieving maximum mesoporosity at the cost of minimal material loss during the desilication. The disclosed ZSM-5 zeolite and method of making the same are directed to overcoming one or more of the problems set forth above and/or other problems of the prior art.

### SUMMARY

To address the foregoing needs, there is disclosed a material having MFI framework type (ZSM-5) that can be desilicated to create higher mesopore volume per unit weight of silica loss compared with the conventionally available materials with MFI framework and similar silica to alumina ratio (SAR) of the parent form.

In an embodiment, a parent ZSM-5 zeolite having SAR range of 15 or more, a mean crystal size of 200 nm or less is selected. The zeolite can be in as-synthesized form (containing OSDA), calcined alkali containing form, ammonium form or proton form, neither of which had been previously subjected to desilication.

In another embodiment, the mesoporosity of the ZSM-5 zeolite is increased by desilication of the parent zeolite. Desilication can be done with a suitable base, such as sodium hydroxide or potassium hydroxide, with or without the presence of quaternary ammonium compounds in the salt or hydroxide form.

In another embodiment, desilication process is conducted at 1-20 mmol of base per gram of anhydrous zeolite, temperatures from 0° C. to 100° C. for 0.5-24 hours, and the solid content between 1 and 30 wt % and optionally in the presence of 0.1-10 mmol of quaternary ammonium compounds in a salt or a hydroxide form per gram of anhydrous zeolite.

In another embodiment, the desilicated form of the zeolite is subjected to ion-exchange with ammonium salts, such as ammonium nitrate or ammonium chloride, optionally in combination with an acid, such as nitric acid or hydrochloric acid.

In another embodiment, the desilicated and ion-exchanged form of the ZSM-5 zeolite has at least 0.8 ΔV/silica loss.

### DESCRIPTION

Definitions

“Micropore volume” or “V_{micro}” is used to indicate the total volume of pores having a diameter of less than 20 Angstroms. “Initial Micropore Volume” means the micropore volume of the freshly made crystalline material before exposing it to any desilication conditions. The assessment of micropore volume is particularly derived from the BET measurement techniques by an evaluation method called the t-plot method (or sometimes just termed the t-method) as described in the literature (Journal of Catalysis 3,32 (1964)).

Herein “mesopore volume” or “mesoporosity” or “Vₘₑₛₒ” is the volume of pores having a diameter of greater than 20 Angstroms up to the limit of 600 Angstroms, as determined by applying BJH method to the desorption branch of N₂ isotherm.

Herein, a “parent zeolite” or “parent material” refers to the initial zeolite material that is for desilicating before it is exposed to any desilication conditions.

“Defined by the Structure Commission of the International Zeolite Association (IZA)” is intended to mean those structures included but not limited to, the structures described in “Atlas of Zeolite Framework Types,” ed. Baerlocher et al. Sixth Revised Edition (Elsevier 2007), which is herein incorporated by reference in its entirety.

Silica loss is calculated as follows: silica loss=1−SAR_{d}/SARₚ, where SAR_{d} is the SAR of the alkali-form or ammonium-form after desilication, SARₚ is the SAR of the parent non-desilicated zeolite, and expressed as percentage.

ΔV is calculated between the difference in the mesopore volume of the ammonium-exchanged desilicated zeolite and the mesopore volume of the ammonium-exchanged non-desilicated zeolite (parent material), and expressed in cc/g.

ΔV/silica loss is calculated as the ratio of ΔV to the silica loss and represents the increase of mesopore volume per percentage of silica loss.

“Mean crystal size” is the average size of zeolite crystals along the longest crystal dimension averaged over randomly selected 100 crystals from SEM micrographs.

“Small crystal ZSM-5 zeolite” is defined as a ZSM-5 material having a mean crystal size of about 200 nm or less, such as 150 nm or less, 100 nm or less, 50 nm or less, or even 40 nm or less. In various embodiments, the small crystal ZSM-5 zeolite has a mean crystal size ranging from 40-200 nm, such as 40-150 nm or even 50-100 nm.

Applicants have surprisingly discovered that selecting a zeolite with MFI framework having specific parameters can be advantageously used to desilicate such material at a higher efficiently (higher ΔV/silica loss) than a conventional commercial zeolite with MFI framework.

In a first embodiment, there is described a ZSM-5 zeolite, wherein the zeolite has SAR of 15 or more and a mean crystal size of 200 nm or less. The zeolite can be in as-synthesized form (containing OSDA), calcined alkali containing form, ammonium form or proton form, neither of which had been previously subjected to desilication.

Applicants have also surprisingly discovered that the presence of an OSDA in the parent zeolite can be advantageously used to desilicate such material at an even higher efficiently (higher ΔV/silica loss) than a conventional commercial zeolite with MFI framework or inventive zeolite with MFI framework in calcined OSDA-free form.

In another embodiment, the mesoporosity of the ZSM-5 zeolite is increased by desilication of the zeolite. Desilication can be done with a suitable base, such as sodium hydroxide or potassium hydroxide. The mixture of zeolite and a base solution is defined as the desilication suspension or desilication slurry. Optionally, quaternary ammonium compounds in the salt or hydroxide form can be added to the desilication slurry.

In another embodiment, desilication process is conducted using 1-20 mmol of base per gram of anhydrous zeolite. The temperature of the desilication process can be in the range from 0° C. to 100° C. The total time of desilication can be in the range of 0.5 to 24 hours. The solid content defined as the percentage weight of the anhydrous zeolite to the total weight of the desilication slurry can range from 1 to 40 wt %.

In another embodiment, at least one quaternary ammonium compound in a salt or hydroxide form can optionally be added to the desilication slurry in the range of 0.1-10 mmol/g of quaternary ammonium compounds per gram of anhydrous zeolite.

In another embodiment, the desilicated form of the zeolite is subjected to ion-exchange in order to remove the alkali cations from the zeolite. Ion exchanged is typically done using ammonium salts, such as ammonium nitrate or ammonium chloride.

In another embodiment, acid, such as nitric acid or hydrochloric acid, can be used in addition to ammonium salt during the ion-exchange to facilitate dealumination of the desilicated mesoporous zeolite. Ion-exchange is conducted using 1-50 mmol of ammonium salt and optionally 1-20 mmol of acid per gram of anhydrous zeolite. The temperature of the ion-exchange process can be in the range from 20° C. to 100° C. The total time of ion-exchange can be in the range of 0.5 to 24 hours. The ion-exchange can be repeated to achieve the desired residual amount of alkali in the zeolite.

In another embodiment, the desilicated and ion-exchanged form of the ZSM-5 zeolite has at least 0.8 ΔV/silica loss.

### EXAMPLES

The following non-limiting examples, which are intended to be exemplary, further clarify the present disclosure.

### Example 1

50 grams of the 51 SAR ZSM-5 zeolite in calcined OSDA-free form with a mean SEM crystal size of 50 nm shown in Table 1 was added to 238 grams of DI water and mixed at room temperature. 29 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Example 2

50 grams of the same starting material as in Example 1 was added to 229 grams of DI water and mixed at room temperature. 38 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Example 3

50 grams of the same starting material as in Example 1 was added to 257 grams of DI water and heated to 40° C. 9.5 grams of 50 wt % sodium hydroxide solution was added to the zeolite suspension in water and the resulting mixture was stirred at 40° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Example 4

50 grams of the same starting material as in Example 1 was added to 248 grams of DI water and heated to 60° C. 19 grams of 50 wt % sodium hydroxide solution was added to the zeolite suspension in water and the resulting mixture was stirred at 60° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Example 5

100 grams of the 30 SAR ZSM-5 zeolite in as-synthesized OSDA-containing form with a mean crystal size of 40 nm shown in Table 1 was added to 421 grams of DI water mixed at room temperature. 71 grams of 50 wt % sodium hydroxide solution was added to the zeolite suspension in water and the resulting mixture was stirred at room temperature for 2 hours. Then, the desilicated zeolite was filtered and washed with DI water.

Acidified ammonium exchange of the desilicated zeolite was done using one contact with a mixture of nitric acid and ammonium nitrate solution (0.6:2.5:1 nitric acid:ammonium nitrate:zeolite weight ratio) and one contact with ammonium nitrate solution (2.5 ammonium nitrate to zeolite weight ratio) at 80° C. for 2 hours. After each contact, the zeolite was filtered and washed with DI water. The ion-exchanged sample was dried in air at 105° C. The ion-exchanged sample exhibited the properties summarized in Table 1.

### Comparative Example 1

Comparative CBV 5524G zeolite, a commercial zeolite produced by Zeolyst International, having a mean crystal size of 230 nm shown in Table 1 was processed under the same conditions as the inventive ZSM-5 in Example 1. 50 grams of the comparative ZSM-5 zeolite was added to 232 grams of DI water and mixed at room temperature. 28 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Example 2

Comparative CBV 5524G zeolite, a commercial zeolite produced by Zeolyst International, was processed under the same conditions as the inventive ZSM-5 in Example 2. 50 grams of the comparative ZSM-5 zeolite was added to 223 grams of DI water and mixed at room temperature. 37 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Example 3

Comparative CBV 5524G zeolite, a commercial zeolite produced by Zeolyst International, was processed under the same conditions as the inventive ZSM-5 in Example 3. 50 grams of the comparative ZSM-5 zeolite was added to 251 grams of DI water and heated to 40° C. 9.3 grams of 50 wt % sodium hydroxide solution was added to the zeolite suspension in water and the resulting mixture was stirred at 40° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Example 4

Comparative CBV5524G zeolite, a commercial zeolite produced by Zeolyst International, was processed under the same conditions as the inventive ZSM-5 in Example 4. 50 grams of the comparative ZSM-5 zeolite was added to 241 grams of DI water and heated to 60° C. 19 grams of 50 wt % sodium hydroxide solution was added to the zeolite suspension in water and the resulting mixture was stirred at 60° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Example 5

Comparative 25 SAR ZSM-5, a commercial CBV 2314 zeolite produced by Zeolyst International, was processed under the same conditions as the inventive ZSM-5 in Example 5. 100 grams of the comparative zeolite was added to 421 grams of DI water mixed at room temperature. 71 grams of 50 wt % sodium hydroxide solution was added to the zeolite suspension in water and the resulting mixture was stirred at room temperature for 2 hours. Then, the desilicated zeolite was filtered and washed with DI water.

Acidified ammonium exchange of the desilicated zeolite was done using one contact with a mixture of nitric acid and ammonium nitrate solution (0.6:2.5:1 nitric acid:ammonium nitrate:zeolite weight ratio) and one contact with ammonium nitrate solution (2.5 ammonium nitrate to zeolite weight ratio) at 80° C. for 2 hours. After each contact, the zeolite was filtered and washed with DI water. The ion-exchanged sample was dried in air at 105° C. The ion-exchanged sample exhibited the properties summarized in Table 1.

TABLE 1
Analytical data for parent materials and the materials
prepared in Inventive and Comparative Examples

| | Mean | | | | | | | | |
|---|---|---|---|---|---|---|---|---|---|
| | SEM | | | | | | | | |
| | crystal | | | | Silica | | | | ΔV/ |
| | size, | NaOH:Zeolite | T | | Loss | V_{micro} | Vₘₑₛₒ | ΔV | silica |
| Example | nm | mmol:g | ° C. | SAR | wt % | cc/g | cc/g | cc/g | loss |
| Small-Crystal | 50 | — | — | 51 | — | 0.14 | 0.26 | — | — |
| Small-Crystal | 40 | — | — | 32 | — | 0.11 | 0.47 | — | — |
| CBV 5524G | 230 | — | — | 62 | — | 0.14 | 0.11 | — | — |
| CBV 2314 | 290 | — | — | 24 | — | 0.15 | 0.04 | — | — |
| Example 1 | 50 | 7.5 | 20 | 44 | 14% | 0.13 | 0.53 | 0.27 | 1.9 |
| Example 2 | 50 | 10.0 | 20 | 43 | 16% | 0.13 | 0.53 | 0.27 | 1.7 |
| Example 3 | 50 | 2.5 | 40 | 44 | 13% | 0.13 | 0.39 | 0.13 | 1.0 |
| Example 4 | 50 | 5.0 | 60 | 34 | 34% | 0.12 | 0.56 | 0.30 | 0.9 |
| Example 5 | 40 | 10.0 | 20 | 36 | 12% | 0.13 | 0.80 | 0.33 | 2.8 |
| Comp. Ex. 1 | 230 | 7.5 | 20 | 55 | 12% | 0.11 | 0.18 | 0.07 | 0.6 |
| Comp. Ex. 2 | 230 | 10.0 | 20 | 55 | 11% | 0.13 | 0.21 | 0.10 | 0.9 |
| Comp. Ex. 3 | 230 | 2.5 | 40 | 55 | 11% | 0.12 | 0.17 | 0.06 | 0.5 |
| Comp. Ex. 4 | 230 | 5.0 | 60 | 44 | 28% | 0.12 | 0.29 | 0.18 | 0.6 |
| Comp. Ex. 5 | 290 | 10.0 | 20 | 23 | 5% | 0.14 | 0.08 | 0.04 | 0.8 |

Alternative implementations will be apparent to those skilled in the art from consideration of the specification and practice disclosed herein. It is intended that the specification and examples be considered as exemplary only, with a true scope of the disclosure being indicated by the following claims and their equivalents.

What is claimed is:

1. A desilicated crystalline material comprising an WI (ZSM-5) framework type, a molar silica to alumina ratio (SAR) of 15 or more, and mean crystal size of about 200 nm or less, wherein the crystalline material has a mesopore volume of at least 0.40 cm³/g and a micropore volume of at least 0.10 cm³/g.

2. The desilicated crystalline material claim 1, wherein said material has a mean crystal size of about 100 nm or less.

3. The desilicated crystalline material claim 1, wherein said material has a mean crystal size ranging from 40 to 200 nm.

4. The desilicated crystalline material claim 1, wherein said material has a mean crystal size ranging from 50 to 100 nm.

5. The desilicated crystalline material of claim 1, wherein said material has a molar SAR ranging from 15 to 300.

6. The desilicated crystalline material of claim 1, wherein said material contains an organic structure directing agent (OSDA) in the amount ranging from 0.1 to 10 wt %.

7. A method of preparing a desilicated crystalline material comprising an WI (ZSM-5) framework type, a molar silica to alumina ratio (SAR) of 15 or more, and mean crystal size of about 200 nm or less, wherein the crystalline material has a mesopore volume of at least 0.40 cm3/g and a micropore volume of at least 0.10 cm3/g, said method comprising:
mixing a parent material having a mean crystal size of 200 nm or less in a base solution,
collecting the solids by filtration or other separation methods,
drying, and
optionally calcining the solids.

8. The method of claim 7, wherein the parent material is mixed in a base solution with 1-20 mmol of base per gram of anhydrous zeolite at a temperature range from 0° C. to 100° C. for a period of time sufficient to create a mesopore volume of 0.40 cm³/g or more,
wherein the solid content defined as the percentage weight of the anhydrous zeolite to the total weight of the desilication slurry ranges from 1 to 40 wt %.

9. The method of claim 7, wherein the desilicated crystalline material is further processed to NH₄-form and H-form by ion-exchange with an ammonium salt or an acid.

10. The method of claim 9, wherein the ammonium salts comprises ammonium nitrate or ammonium chloride.

11. The method of claim 10, further comprising treating the desilicated crystalline material with an acid during ion-exchange to facilitate dealumination of the desilicated mesoporous zeolite.

12. The method of claim 11, wherein the acid comprises nitric acid or hydrochloric acid.

13. The method of claim 7, wherein the parent material is free of OSDA.

14. The method of claim 7, wherein the parent material contains OSDA.

15. The method of claim 7, wherein the parent material has a molar silica to alumina ratio ranging from 15 to 300.

16. The method of claim 7, wherein the base is chosen from alkali metal hydroxides.

17. The method of claim 7, wherein the base comprises LiOH, NaOH, KOH, or NH₄OH.

18. The method of claim 7, wherein the base is chosen from an organic base comprising tetraalkylammonium hydroxide.

19. The method of claim 7, wherein the desilicated material has ΔV/silica loss ratio of at least 0.8.

20. The method of claim 7, wherein said material has a mean crystal size ranging from 40 to 200 nm.

21. The method of claim 7, wherein said material has a mean crystal size ranging from 50 to 100 nm.
